(19) United States
(12) Patent Application Publication
(10) Pub. No.: US 2013/0343562 A1
(43) Pub. Date: Dec. 26, 2013

(54) EARRING SET WITH AN AUDIO SPEAKER INTEGRATED THEREIN

(71) Applicant: AAB co. limited, Guangzhou (CN)

(72) Inventor: Yaakov Amsalem, Zikhron Ya'akov (IL)

(21) Appl. No.: 13/922,520

(22) Filed: Jun. 20, 2013

Related U.S. Application Data
(60) Provisional application No. 61/662,569, filed on Jun. 21, 2012.

(51) Int. Cl. H04R 1/10

(52) U.S. Cl. CPC H04R 1/105
USPC 381/74

(57) ABSTRACT

An earring set that includes an earring that can be fastened to at least one pierced hole of a body part of a subject. The earring includes an earring stud having a first edge and a second edge, where the earring stud is configured for being inserted through the pierced hole; and a speaker unit that includes one or more audio speakers. The speaker unit is attachable to the first edge of the stud such that it is located externally to the pierced hole when the earring is worn. The speaker of the earring is electrically or wirelessly communicable directly with an audio player or to an amplifier that amplifies signals of an audio player via a signal unit. The signal unit is configured for receiving electromagnetic signals from an audio player or an amplifier and for directing the signals to each speaker for outputting audio signals corresponding thereto.

### CROSS-REFERENCE TO RELATED PATENT APPLICATIONS

This application claims priority to Provisional patent application No. 61/662,569 filed on Jun. 21, 2012, which is incorporated herein by reference in its entirety.

### FIELD OF THE INVENTION

The present invention generally relates to audio system and devices and to jewelry items and more particularly to audio systems and devices that include an earring having a speaker integrated therein.

### BACKGROUND OF THE INVENTION

US patent application no. 2012308069 discloses an apparatus and a system to play audio signals from an audio source. The apparatus is positionable within a fistula defining a channel extending through a pinna of an ear of a user from a first surface of the pinna to a second surface of the pinna such that the channel extends through an entire width of the pinna. The apparatus includes a housing, a speaker, and an audio signal receiving member. The housing is positionable within the channel in the ear of the user and includes an enclosure defining a speaker receiving space. The speaker is positioned within the speaker receiving space. In an engaged position, at least a portion of the speaker is positioned within the channel in the ear of the user. The audio signal receiving member is electrically coupled to the speaker and is communicably coupleable with the audio source.

US patent application no. 2008311966 discloses a battery-powered miniature wireless headset worn as a single earring or as a pair of earrings. The headset communicates with a phone or other host over a bidirectional wireless communication link allowing hands-free operation. The wireless earring headset is comprised of an electronics module, a speaker assembly, a microphone assembly, an antenna, a battery, user interface devices such as a switch and LED, and an attachment means employing either a clamp or a pierced earring post with clutch. The electronics module, which may be a single chip, comprises a wireless transceiver, a processor with associated memory, an audio codec, power supply electronics, and other components. In use the device is attached to the pinna of the wearer's ear using either a clamp or a post inserted through a pinna piercing and secured by a clutch or nut. The clamp or post may be permanently attached to the device or removably attached using a magnetic or mechanical attachment means. The user positions the speaker inside of, or at the entrance to, the ear canal. The microphone is mounted in such a way that it points toward the user's mouth and may be positioned on a boom to move it closer to the mouth.

A patent no. GB2402835 discloses a headset for use with mobile phones, personal music players or other mobile communications devices is designed to be attached to the user's body by means of a stud into a piercing. It can be attached to the earlobe and may incorporate a battery, transmitter, receiver, aerial, microphone and speaker in one unit. The headset can communicate with the mobile phone via Bluetooth technology.

US patent application no. US2002039427 discloses an audio apparatus that includes a transducer and a coupler for coupling the transducer to a user's pinna. The coupler may be in the form of a hook, and leads connect the audio apparatus to a remote sound source. The transducer is mounted to a lower straight end of the hook. An upper curved end of the hook hooks over the junction between the user's ear and head so that the transducer touches a lower rear face of the pinna adjacent the concha. The transducer excites vibration in the pinna whereby an acoustic signal from the transducer is transmitted to the user's inner ear by radiation of pressure waves and/or by conduction of vibrational energy through the outer and middle ear.

### SUMMARY OF THE INVENTION

This section will be drafted once the claims are approved.

### BRIEF DESCRIPTION OF THE DRAWINGS

FIG. 1 shows an audio system that includes two stud earrings each having a speaker integrated therein, according to some embodiments of the present invention.

FIG. 2 shows an earring with speaker worn on an ear, according to some embodiments of the present invention.

FIG. 3 shows an electronic circle diagram that is in the amplifier, according to some embodiments of the present invention.

FIGS. 4A-4B show an amplifier of the audio system, according to some embodiments of the present invention: FIG. 4A shows an isometric view of the amplifier and FIG. 4B shows a top view of the amplifier.

FIG. 5 shows an earring with a speaker integrated therein, in which the tube shape stud of the earring acts as an electric connector, where the positive node or inlet of the connector is an elongated member threaded through the tube of the stud and the negative node or inlet is formed by a the stud itself surrounding the elongated positive node or inlet, according to other embodiments of the present invention.

FIGS. 6A-6B show a signal unit which is an electric connector for electrically connecting the speaker in the earring shown in FIG. 5 to an audio player, according to some embodiments of the invention.

FIG. 7 shows an earring with a speaker integrated therein, in which the tube shape stud of the earring acts as an electric connector, where the positive node or inlet of the connector is an elongated member threaded through the tube of the stud and the negative node or inlet is formed by a the stud itself surrounding the elongated positive node or inlet, according to other embodiments of the present invention.

FIGS. 8A-8B show a signal unit which is an electric connector for electrically connecting the speaker in the earring shown in FIG. 5 to an audio player, according to some embodiments of the invention.

FIG. 9 shows an earring with a speaker integrated therein, according to other embodiments of the present invention.

FIGS. 10A-10B show a signal unit which is an electric connector for electrically connecting the speaker in the earring shown in FIG. 9 to an audio player, according to some embodiments of the invention.

FIG. 11 shows a perspective view of a wire connector for connecting an earring speaker to an audio player and/or to an amplifier, according to other embodiments of the present invention.

FIGS. 12A, 12B and 12C show how the stud of a speaker earring can be threaded through various types of flexible adaptors to fit the earring to different sizes of pierced holes of subjects, according to some embodiments of the invention.

FIG. 13 schematically illustrates how the speaker earring 110 can be used only as a jewelry piece by fastening it to the ear lobe of the subject through various standard earring-fasteners such as fasteners, according to some embodiments of the invention.

FIG. 14 schematically illustrates an earring based on cable electric communication is worn over an ear lobe, according to some embodiments of the invention.

FIG. 15 schematically illustrates an earring based on wireless (Bluetooth) communication is worn over an ear lobe, according to some embodiments of the invention.

FIG. 16 shows a USB charging connector for wirelessly communicating the audio player and the earring speaker device, according to some embodiments of the invention.

FIG. 17 shows an audio system that includes two stud earrings each having a speaker integrated therein, where the system is based on wireless communication, according to some embodiments of the present invention.

FIGS. 18A-18C show an earring with a speaker integrated therein, according to another embodiment of the invention: FIG. 18A shows the earring worn over a subject's upper ear portion; FIG. 18B shows a top view of the earring; and FIG. 18C shows a ring shaped closure element that can be attached to the earring stud for decorative and/or fastening purposes.

FIGS. 19A-19B show an earring with an audio speaker embedded therein, according to yet another embodiment of the invention: FIG. 19A shows a cross sectional view of the earring installed inside an ear pierced hole; and FIG. 19B shows a front view of the installed earring.

FIGS. 20A-20B show an earring with an audio speaker embedded therein, according to another embodiment of the invention: FIG. 20A shows an isometric view of the earring attachable to a signal unit connector; and FIG. 20B shows a side view of the earring and signal unit connector.

FIGS. 21A-21C show another embodiment of a set including an earring having an audio speaker integrated therein and an electric connector type signal unit: FIG. 21A shows a side view of the set; FIG. 21B shows a front view of the set; and FIG. 21C shows how the earring fastens to an ear via a piercing hole therein.

FIGS. 22A-22C show another embodiment of a set including an earring having two audio speakers integrated therein and an electric connector type signal unit: FIG. 22A shows a rear view of the set; FIG. 22B shows a side view of the set; and FIG. 22C shows how the set fastens to an ear via a piercing hole therein.

FIGS. 23A-23B show an earring set that includes two speakers, according to one embodiment of the invention: FIG. 23A shows a frontal view of the earring set fastened to an ear; and FIG. 23B shows a cross sectional view to show how the stud of the earring is inserted through an ear piercing.

FIGS. 24A-24M show three types of earrings of the present invention allowing various ways in which a person can wear each of them. FIGS. 24A-24J show a ring type earring; FIGS. 24K-24L show an elongated rod type earring; and FIG. 24M shows a button type earring 19c.

FIG. 25 shows an earring with an audio speaker integrated therein, according to yet another embodiment of the invention, for a pair of pierced holes in the body of a person.

FIG. 26 shows a system including an earring and two different speakers one with a first output frequency f₁ and the other with a second output frequency f₂, where the first frequency is substantially higher than the second frequency: f₁>>f₂, according to another embodiment of the invention.

FIGS. 27A-27H show an earring set having a flexible section, according to another embodiment of the invention: FIG. 27A shows a side view of the earring set including an earring and a signal unit serving as a fastener of the earring; FIG. 27B shows the earring; FIGS. 27C-27E show the fastener signal unit; and FIGS. 27F-27H show elements of the earring including the speaker integrated therein and a receiving unit designed to fasted to the signal unit and to receive electric signals therefrom.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides an audio systems and devices having one or more earrings, each erring includes one or more audio speaker embedded therein for allowing a human or animal subject to play audio signals (e.g. music, radio etc.) from his/her earrings while wearing them. The earring of some embodiments of the present invention is designed to allow connecting and disconnecting to a stationary or mobile/portable audio device also referred to as an “audio player” in this document, such as an MP3 player, a radio device, a CD player, a smartphone, a laptop and PC computer and the like in an easy and comfortable manner. The system includes one or more such stud or other types of speaker embedded earrings, connecting or receiving means for receiving signals from the audio player and transmitting them to the one or more speakers for outputting audio signals corresponding thereto and optionally also an amplifier for amplifying signals arriving g from the audio player.

Each earring may be designed such that the speaker thereof is located externally to the body part it attaches to such as at an external side of the ear lobe while the part connecting the earring to the body part (such as a clip or a stud inserted through a perforated channel in the subject's body part) allows electromagnetic signal transmission to the speaker.

The earring may be configured for receiving electromagnetic signals through wireless or cabled communication. For example, the audio player may connect to the earring speaker through an electric cable, by connecting to the earring stud, for instance, through an electric connector (e.g. removable plug). In this case the stud may be designed to allow electric connection through electrodes embedded therein. In another example, the earring may be designed to receive electromagnetic signals through wireless communication, for instance be including a Bluetooth receiver receiving RF signals therethrough. In this case, the audio player or the amplifier of the system connecting to the audio player may include a wireless transmitter or transceiver such as a Bluetooth transceiver. The electromagnetic signals received by each speaker are translated thereby into audio signals as known in the art.

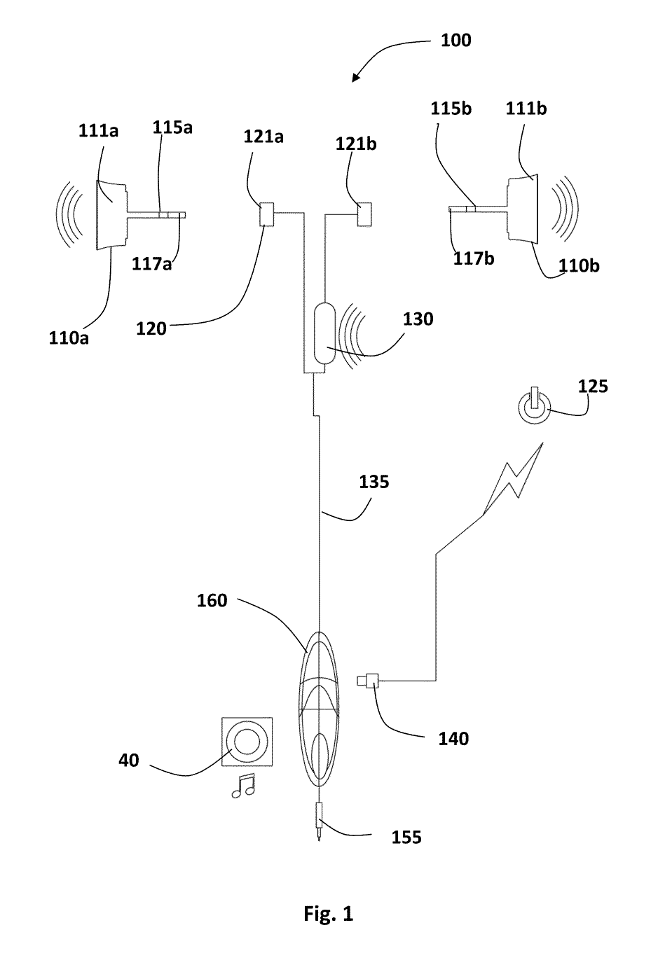

Reference is now made to FIG. 1, which shows an audio system 100 having two earrings 110a and 110b each earring includes an audio speaker unit 120a and 120b, respectively. The system 100 further includes a signal unit 120 having two electric connectors 121a and 121b for electrically connecting the speaker units 120a and 120b to an audio player such as to an MP3 device 40 through an electric cable 135. The system 100 may further include a microphone 130 connected through the cable 135 for allowing a user of the system 100 to input audio signals therethrough.

Each earring 110a or 110b includes a speaker 111a or 111b, a connector for connecting the earring to a body part such as the ear of the user such as an earring stud 115a or 115b. In case of a stud earring 110a or 110b such as illustrated in FIG. 1, a first edge of the stud 115a/115b connect to the speaker 111a/111b and the other edge may include an electric connection 117a/117b (e.g. an electric inlet) for connecting to the cable 135 connectors 121a/121b respectively.

According to some embodiments, as illustrated in FIG. 1, the system 100 includes an amplifier 160 for amplifying the signals received from the audio player and optionally also from the microphone 130. FIG. 1 shows one optional design of the system 100 in which the cable 135 splits into two cables each directed to a different connector 121a and 121b at one end through the microphone 130 and connects to the amplifier 160 while terminating at a plug connector 155 that allows connecting to an audio player.

According to some embodiments, each connector 120a/120b is also designed to fasten the earring 110a/110b to the body part (e.g. to the ear lobe) by having, for example, an earring closure design.

According to some embodiments of the present invention, as illustrated in FIG. 1 the amplifier 160 may be charged by a power source 125 via a Universal Serial Bus (USB) cable having a USB connector 140 on one side that may connect to the amplifier 160 and a USB connector that may be connected to the power source 125.

Reference is now made to figures FIG. 2, showing a stud earring 110 having a speaker 110 integrated therein worn over an ear 10 of a subject, according to some embodiments of the present invention. The earring 110 connects to the audio player or amplifier through a connector 120, which is also the signal unit. The connector 120 also serves a fastener of the earring 110 by perpendicularly fastening to the earring 110 stud. The connector 120 may connect to a cable or a plug 20 for electrically connecting to the amplifier or audio player.

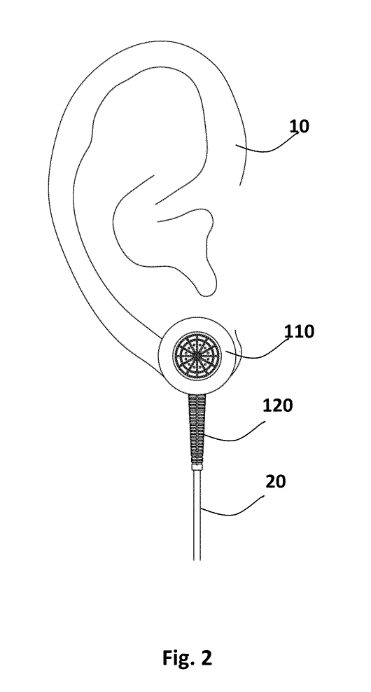

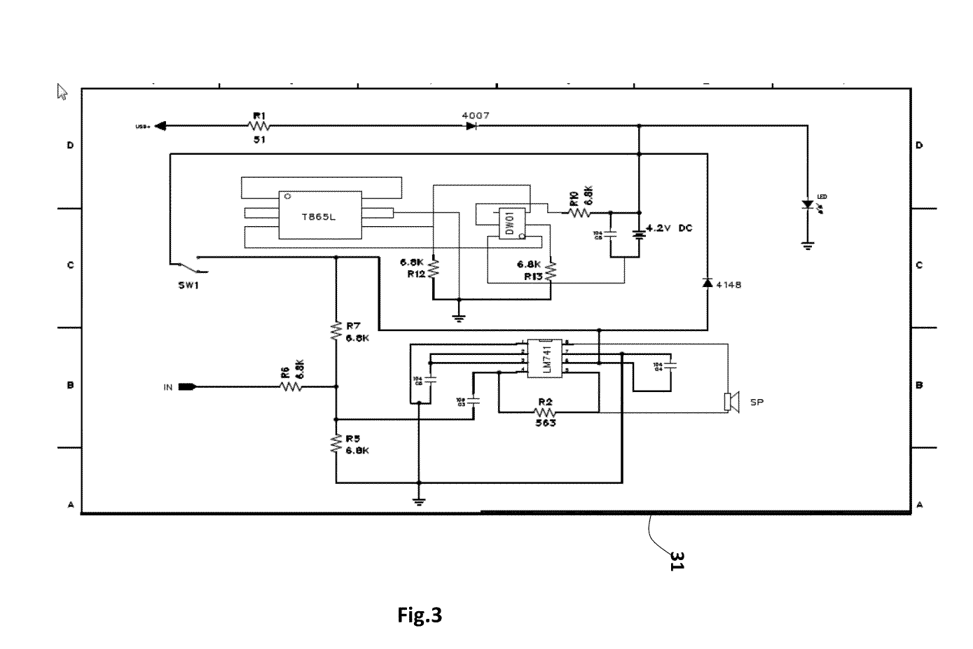

Reference is now made to FIG. 3, showing an electronic circuit diagram 31 of the amplifier 160, according to some embodiments of the present invention. The electronic circuit is designed to adjust the volume in the speaker, such that it can be heard not only by the person using the erring but also for other people in the surrounding area.

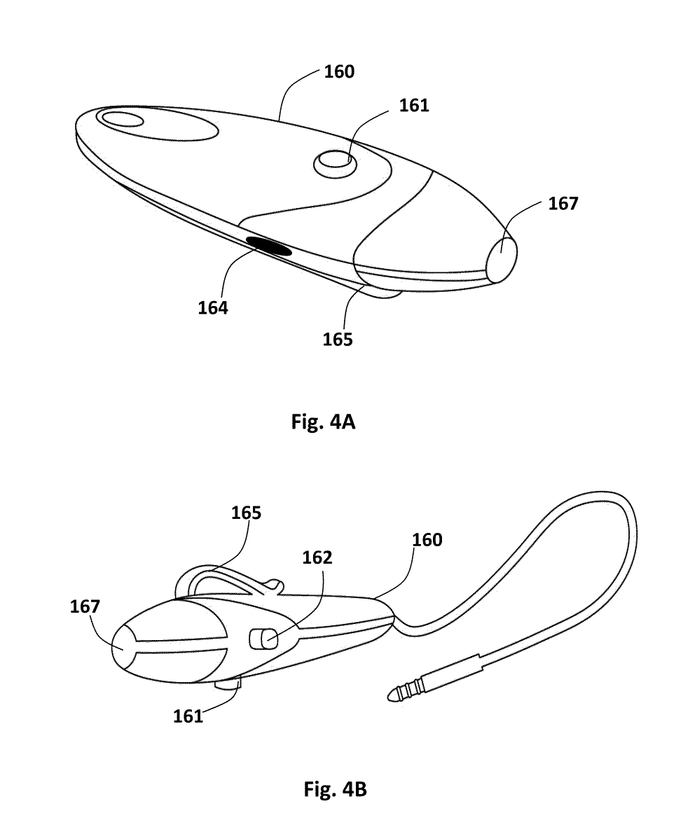

According to some embodiments of the invention, as illustrated in FIGS. 4A and 4B, the amplifier 160 includes a chargeable battery (not shown), an inlet 164 for connecting to a charger cable, a power switch 162 for turning the entire amplifier device 160 on and off and thereby disconnecting the earring(s) and its(their) speaker(s) from the audio player and optionally a second switch 161 for disabling the amplifying operation. When switching the second switch 161 to a disabling mode the headset including the earrings speakers can still be used where only the amplification of the signal outputted by the audio player is disabled allowing the output signal to reach the earring(s) speaker(s). When switching the second switch 161 to an enabling mode the amplifier is enabled allowing signal amplification. The power switch 162 however, can prevent signals outputted by the audio player from being transmitted to the speaker(s) when switch 162 is turned to an off position and allow transmission again when the switch 162 is turned on.

Optionally, as illustrated in FIG. 4B, the amplifier 160 also includes a clip 165 for allowing the subject to fasten the amplifier 160 to a clothing edge or to a bag and the like for comfortable carrying thereof. Additionally or alternatively, the amplifier 160 also includes one or more indication lamps such as a LED (Light Emitting Diode) indicator 167 for indicating the battery state and/or the mode of the power switch and/or second switch.

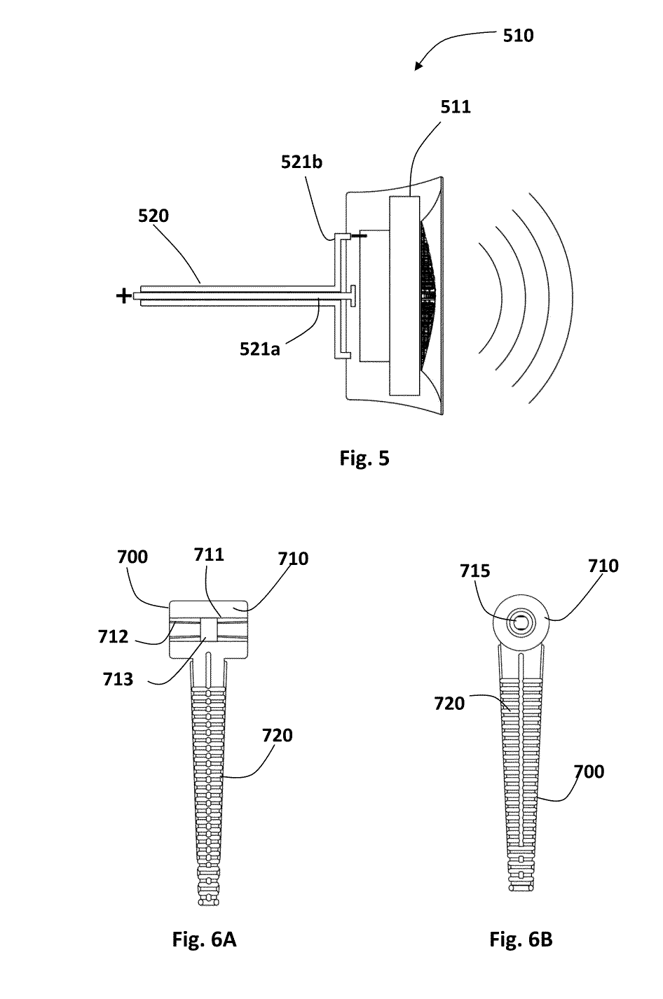

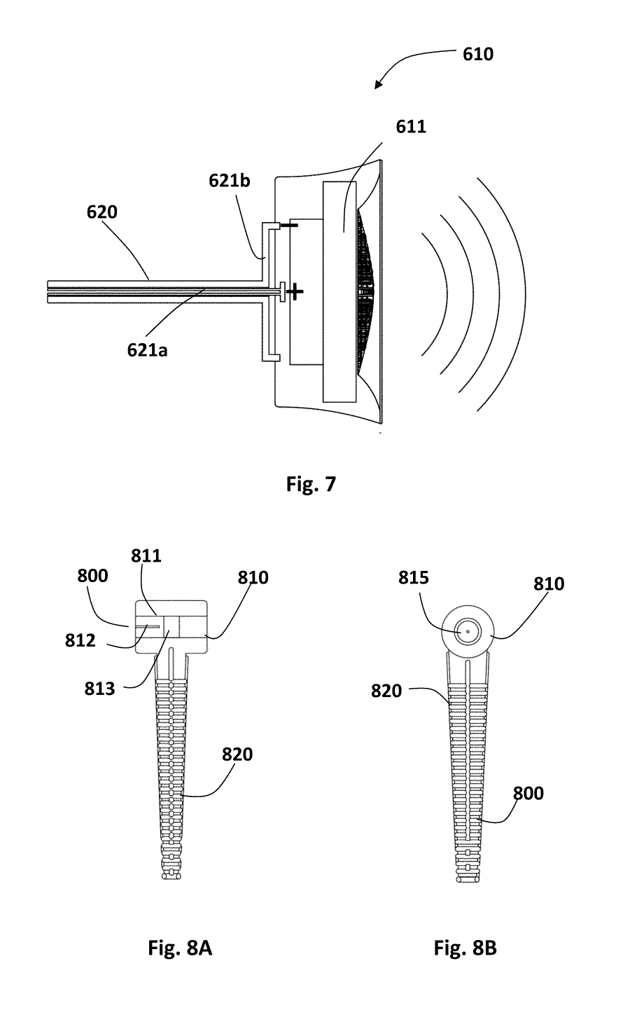

FIGS. 5 and 7 each shows an earring 510/610 with a speaker 511/611 integrated therein, in which a tube shaped stud connector 520/620 of the earring 510/610 acts as an electric connector, where the positive node 521a/621a of the electric connector is an elongated member threaded through the tube of the stud 520/620 and the negative node 521b/621b is formed by the stud 520/620 itself surrounding the elongated positive node 521a/621a, according to other embodiments of the present invention. For example, the positive input 521a ‘+’ 0.2˜0.5 mm isolated wire, wrapped in a pipe. The second input may be a negative input 521b ‘−’ 0.8˜1.2 mm metal pipe.

FIGS. 6A and 6B show a signal unit which is an electric connector 700 for electrically connecting to the speaker 511 in the earring 510 shown in FIG. 5 to an audio player, where the connector 700 also serves as a fastener of the earring 510 for fastening thereof to an ear lobe for instance.

According to some embodiments, the connector 700 includes a head portion 710 and an elongated tail portion 720 configured such that when the connector 700 fastens to the earring stud 520 it is perpendicular to the speaker 511 to allow easy wearing thereof.

The connector 700 has to fit positive and negative wires directed therethrough to form circuit with the positive and negative inputs 521a and 521b of the earring stud 520 to allow electrically connecting the speaker 511 of the earring 510. Therefore, the connector 700 signal unit includes positive and negative electric connections 711 and 712. An electrically isolating element 713 may also be placed inside a channel perforated through the connector 700.

FIGS. 7A and 7B show a signal unit which is an electric connector 800 for electrically connecting the speaker 611 in the earring 610 shown in FIG. 6 to an audio player, where the connector 800 also serves as a fastener of the earring 510 for fastening thereof to an ear lobe for instance.

According to some embodiments, the connector 800 includes a head portion 810 and an elongated tail portion 820 configured such that when the connector 800 fastens to the earring stud 620 it is perpendicular to the speaker 611 to allow easy wearing thereof. The connector 800 signal unit includes positive and negative electric connections 811 and 812. An electrically isolating element 813 may also be placed inside a channel perforated through the connector 800.

The connector 800 has to fit positive and negative wires directed therethrough to form circuit with the positive and negative inputs 621a and 621b of the earring stud 620 to allow electrically connecting the speaker 611 of the earring 610.

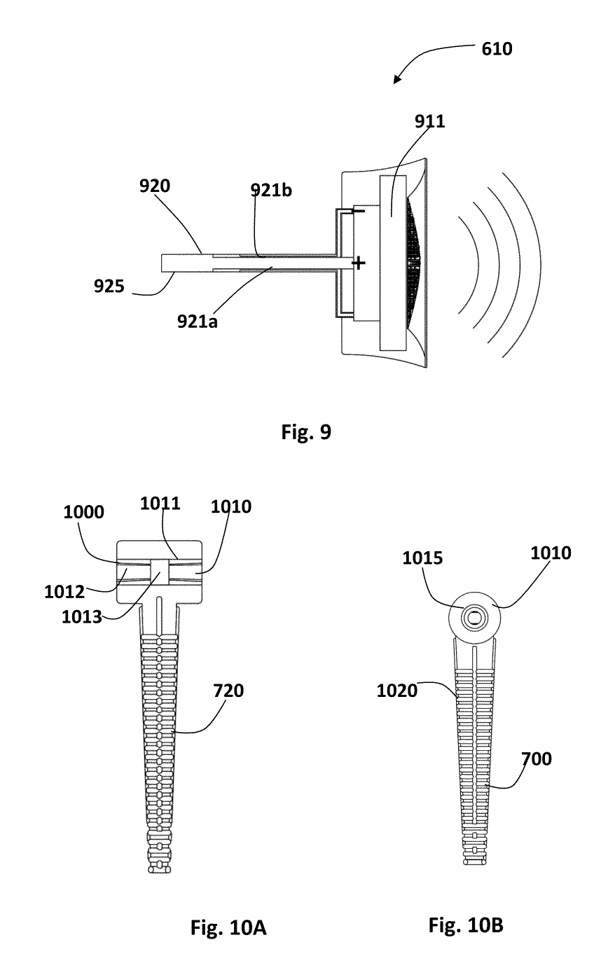

FIG. 9 shows an earring 910 with a speaker 911 integrated therein, in which the connector 920 of the earring 910 acts as an electric connector, where the positive node 921a of the electric connector is on elongated curved pin and the negative node 921b is a second elongated curved pin, according to other embodiments of the present invention. As illustrated in FIG. 9, the connector 900 may further comprise a cap 925 for fitting into a wire connector 1000.

FIGS. 10A and 10B show a signal unit which is an electric connector 700 for electrically connecting the speaker 911 in the earring 910 shown in FIG. 9 to an audio player, where the connector 1000 also serves as a fastener of the earring 910 for fastening thereof to an ear lobe for instance. The connector 1000 signal unit includes positive and negative electric connections 1011 and 1012. An electrically isolating element 1013 may also be placed inside a channel perforated through the connector 1000.

According to some embodiments, as illustrated in FIGS. 6A-6B, 8A-8B and 10A-10B, the tail portion 720, 820 and/or 1020 of the connector 700, 800 and/or 1000, respectively may include or be shaped as a spring to increase flexibility of this portion.

FIG. 11 shows a perspective view of an electric wire connector 70 for connecting an earring speaker to an audio player and/or to an amplifier, according to other embodiments of the present invention. The wire connector 70 includes a head portion 71 and a tail portion 72. The head portion 71 includes a polygonal input 73 for fitting an earring stud therein. A coiled spring 74 surrounds the tail portion 72 of the connector 70 for allowing an electric wire connected thereto to flexibly move therein.

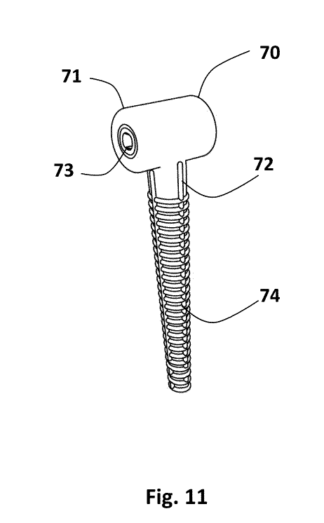

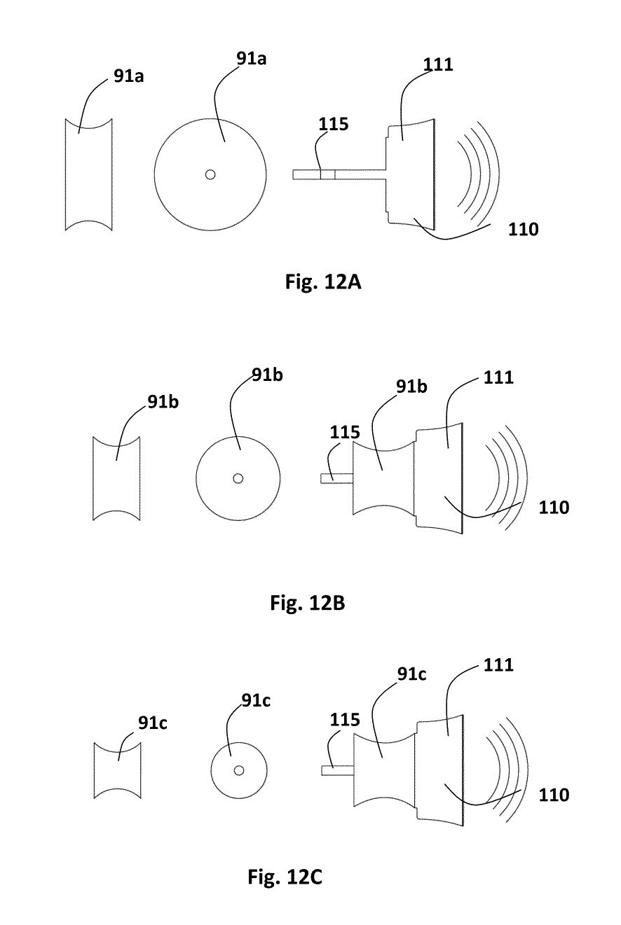

FIGS. 12A-12C show how the stud 115 of the earring 110 with the speaker 111 can be threaded through various types of flexible adaptors such as silicone flesh tunnel adaptors 91a-91c to fit the earring 110 to different sizes of pierced holes of subjects, according to some embodiments of the invention. The respective adaptor 91a/91b/91c is threaded over the stud 115 and the stud 115 covered with the adaptor 91a/91b/91c is then threaded through the pierced hole of the subject's body part (e.g. ear pierce).

According to some embodiments of the present invention, silicon flesh tunnel 91a/91b/91c may have cylindrical symmetry around its main axis having a narrower middle section widening at the edges.

The silicon flesh tunnel 91a/91b/91c may have variable widths ranging from 1.6 mm up to 12 mm. A wide version of the silicon flesh tunnel may be illustrated by adaptor 91a and a thin version of the silicon flesh tunnel may be illustrated by adaptor 91c.

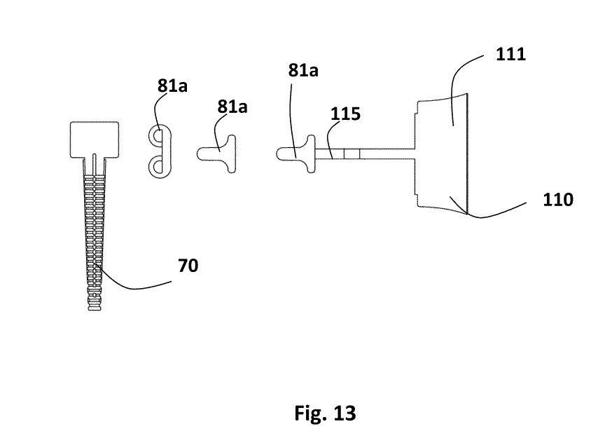

FIG. 13 schematically illustrates how the speaker earring 110 can be used only as a jewelry piece by fastening it to the ear lobe of the subject through various standard earring-fasteners such as fasteners 81a and 81b, wherein once the subject wishes to connect to the audio player he/she simply removes the standard earring fastener and replaces it with the signal unit 70 also serving as an earring fastener as well as cable-connecting or wirelessly communicating with the audio player.

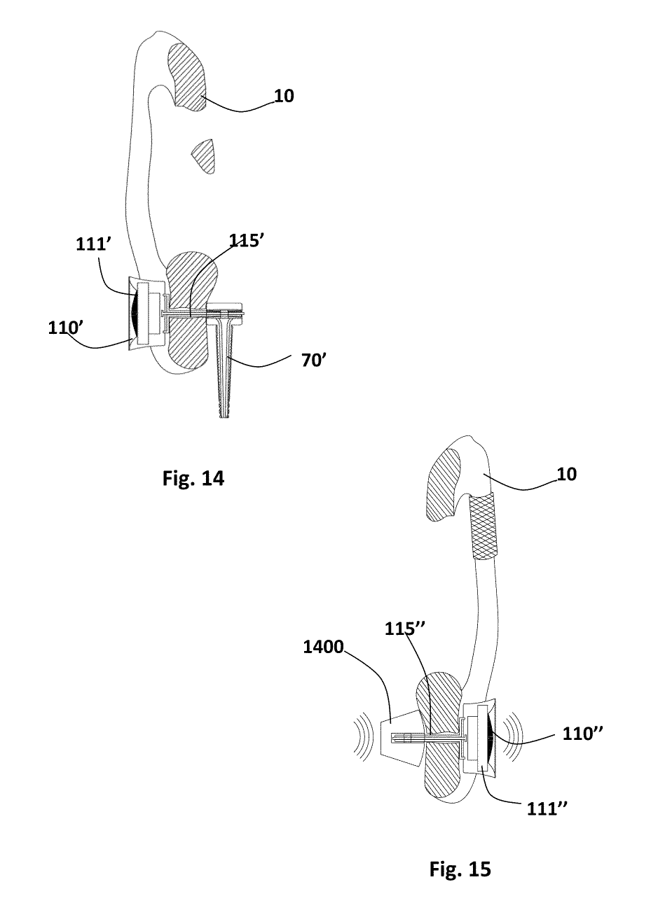

FIG. 14 schematically illustrates an earring 110′ based on cable electric communication is worn over an ear lobe 10, according to some embodiments of the invention. As discussed above, the earring 110′ includes a speaker unit 111′ and a stud 115′, where the stud 115′ is inserted through a pierced hole of the ear lobe of the subject and the speaker 111′ is located externally to the ear lobe. A cable-based signal unit 70′ also serving as an earring fastener connects to the stud 115′ and thereby electrically connects a wire connected thereto to the speaker 111′. The electric wire or cable connects to an amplifier connected to an audio player or connects directly to the audio player.

FIG. 15 schematically illustrates an earring 110″ based on wireless (Bluetooth) communication is worn over an ear lobe 10, according to some embodiments of the invention. In these embodiments, the signal unit 1400 is a Bluetooth receiver configured for wirelessly receiving electromagnetic signals in the RF (Radio Frequency) range. The received RF signals are transmitted through electric communication to the speaker 111″ for outputting audio signals corresponding thereto.

To use the Bluetooth configuration, the audio player and/or the amplifier communicating therewith should be equipped with Bluetooth transmitter or transceiver, as mentioned above.

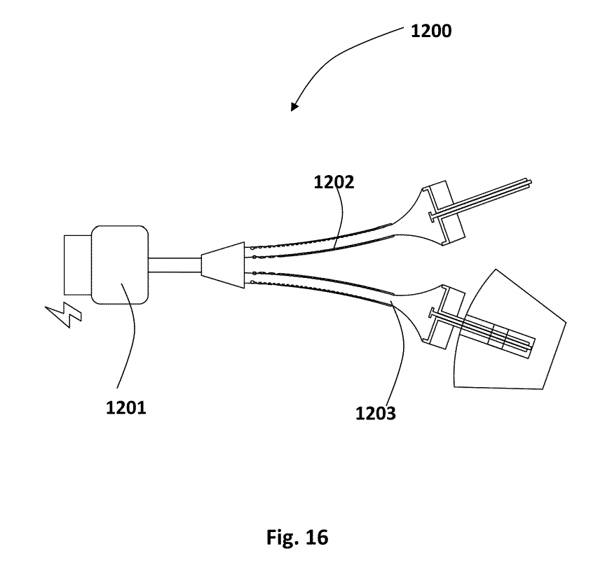

FIG. 16 shows a USB charging connector 1200 having a USB connecting plug 1201 at one edge thereof and two connectors 1202 and 1203 at the other edge thereof where the two connectors 1202 and 1203 split from a single cable. The first connector 1202 is an electric wire enabling digital/electric connection and the other connector 1203 includes a wireless Bluetooth connector for charging the Bluetooth receiver of the signal unit, which is connectable to the earring.

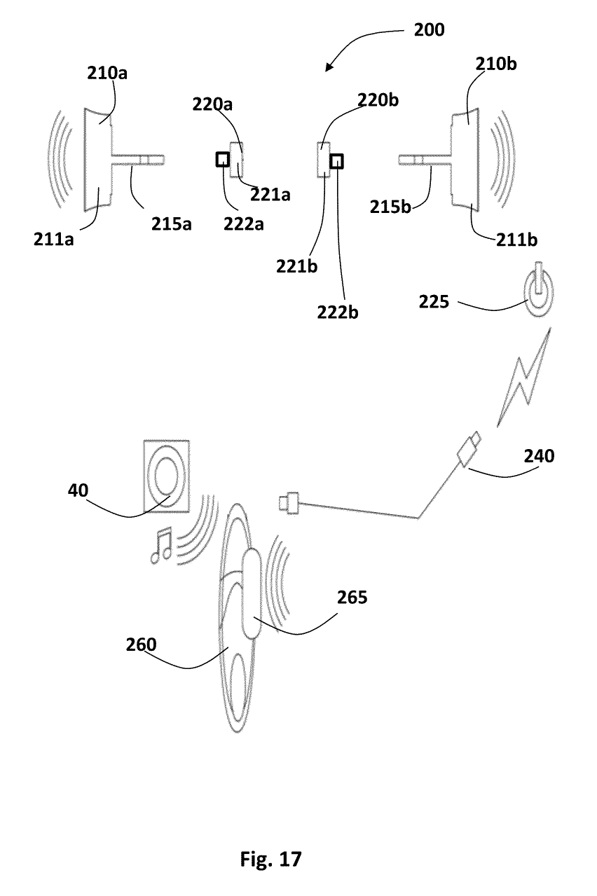

Reference is now made to FIG. 17, which shows an audio system 200 that is based on wireless communication such as RF based Bluetooth communication, according to some embodiments of the invention. The system 200 includes two earrings 210a and 210b each earring includes an audio speaker unit 220a and 220b, respectively. The system 200 further includes separate signal units 220 each having a Bluetooth receiver 221a and 221b an electric connector 222a and 222b electrically connecting to a speaker 211a or 211b respectively for transmitting the received signals thereto.

According to some embodiments, as illustrated in FIG. 17, the system 200 further includes an amplifier 260 with a Bluetooth transceiver embedded therein and a cable connection means for electrically connecting to an audio player 40. The amplifier 260 allows connecting through cabled connection to the audio player 40, amplifying the signals received therefrom and wirelessly transmitting the amplified signals over a RF Bluetooth link to the receivers 221a and 221b of the signal units 220a and 220b. In this way the system 200 including the earrings 110a and 110, the signal units 220a and 220b and the amplifier 260 allow using any standard type of stationary or portable audio player without requiring the player to have a Bluetooth or any other wireless communication abilities.

The amplifier 260 can connect to a power source 225 through a USB cable 240 and connection and may be operable via a chargeable battery.

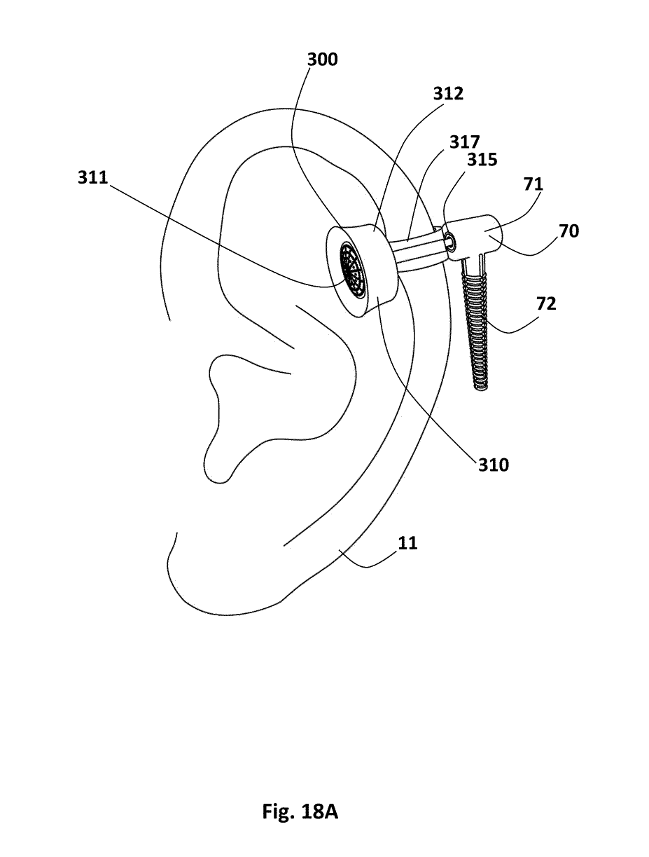

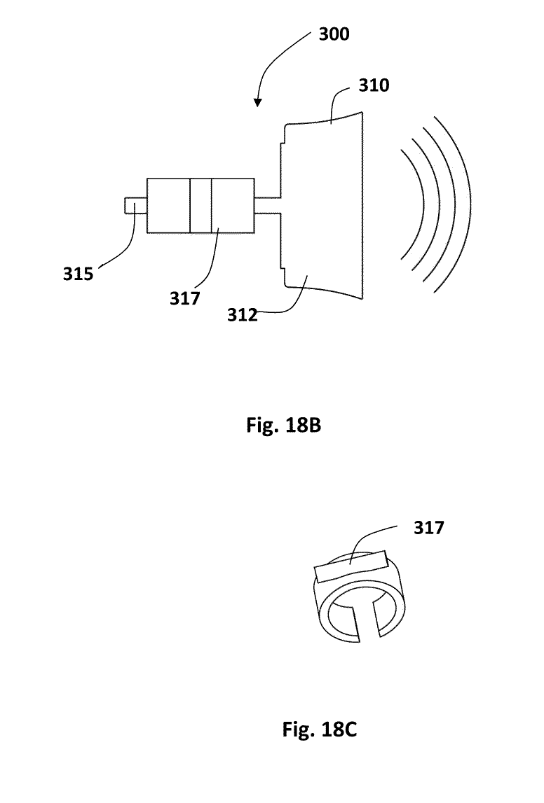

FIGS. 18A-18C show an earring 300 with an audio speaker 311 integrated therein, according to other embodiments of the invention. The earring 300 includes a speaker unit 310 with the audio speaker 311 therein having a decorative cover 312 surrounding the speaker 311; an earring stud 318 connected to the earring stud 315 and the signal unit 70 fastened to the stud 315. When fastened to an upper part of the subject's ear 11 the earring 300 may also attach to a ring shaped closure element 317 for better fastening to the ear 11, which may also serve as a decorative element.

FIGS. 19A-19B show an earring 400 with an audio speaker 411 embedded therein, according to yet another embodiment of the invention. The earring 411 includes a speaker unit 410 with the audio speaker 411 therein having a decorative cover 312 surrounding the speaker 411 and a closure 415 that does not require piercing of the body part (e.g. ear). The closure 415 also includes an electric connection 418 for connecting to an electric connector signal unit 70 also serving as the fastener of the earring 400.

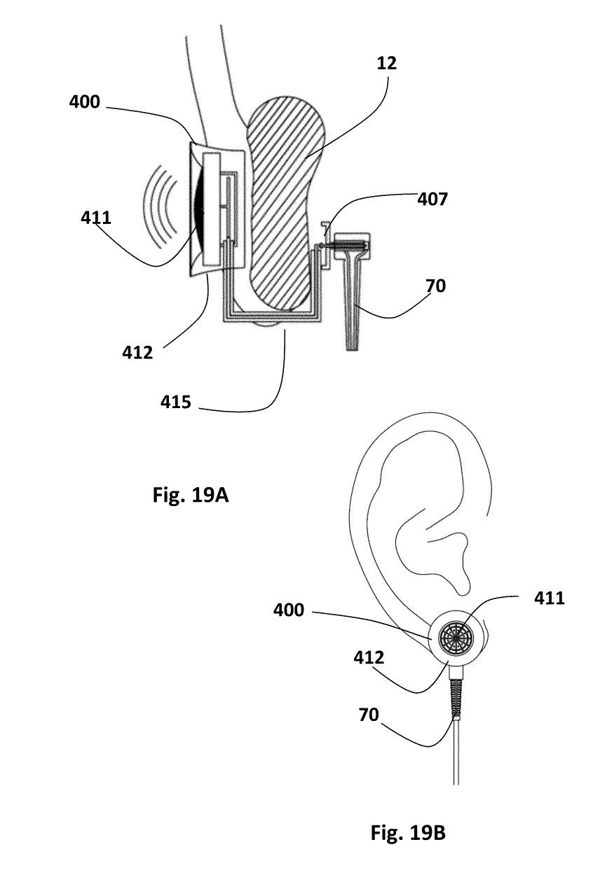

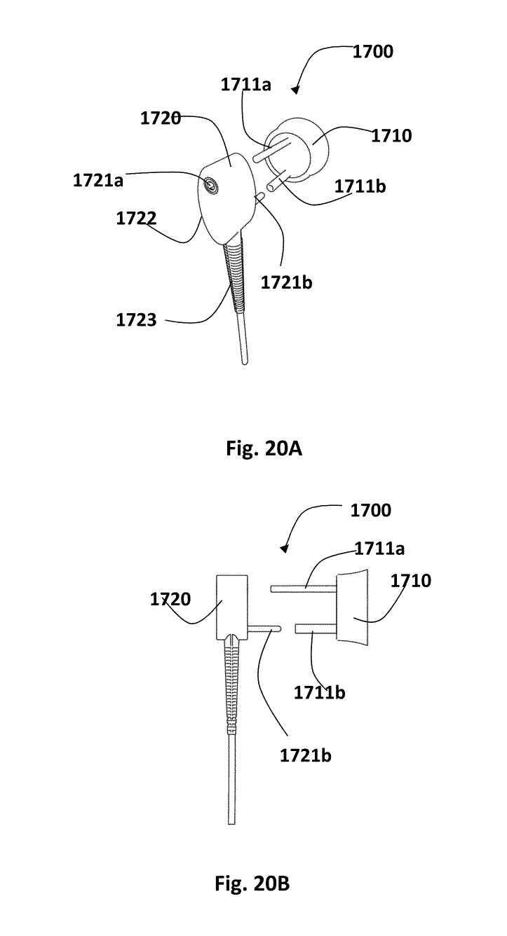

FIGS. 20A-20B show an earring 1700 with an audio speaker embedded therein, according to another embodiment of the invention. The earring 1700 includes a speaker unit 410 and two electric connections 1711a and 1711b. An electric connector type signal unit 1720 is connectable to the earring 1700 via electric connections 1721a and 721b, where each connects to a corresponding connection 1711a/1711b of the earring 1700 speaker unit 1710.

The signal unit 1720 is similar to signal unit 70 discussed above having an upper portion 1722 and a lower portion 1723 where the lower portion 1723 includes a spring cover and is positioned perpendicular to the surface of the speaker unit 1710.

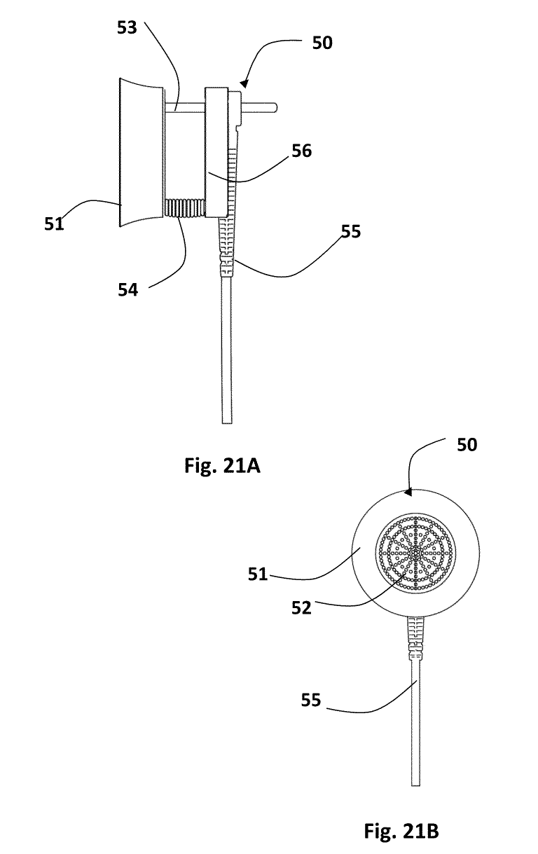

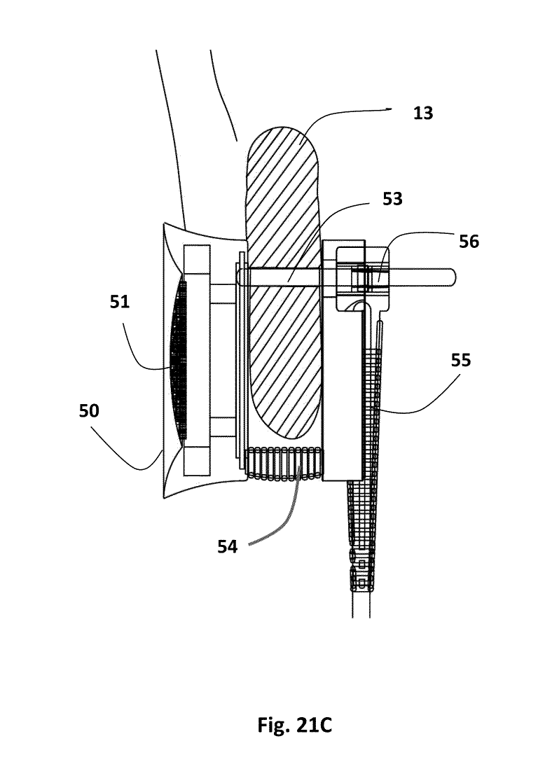

FIGS. 21A-21C show another embodiment of a set including an earring 50 having an audio speaker 52 integrated therein and an electric connector type signal unit 55. This earring 50 includes a speaker unit 51 including the speaker 52 and connectors 53 and 54. The first connector 53 serves as a stud for being inserted into a piercing hole, where the second connector 54 may be made from a flexible material or formed ion a foldable manner to allow its length to be adjusted. The earring 50 is connectable to a designated connector type signal unit 55 that can electrically connect to connectors 53 and 54. FIG. 21C shows how the earring 50 fastens to an ear 13 of a human subject and how a closure 56 of the connector type signal unit 55 holds it attached to the earring 50.

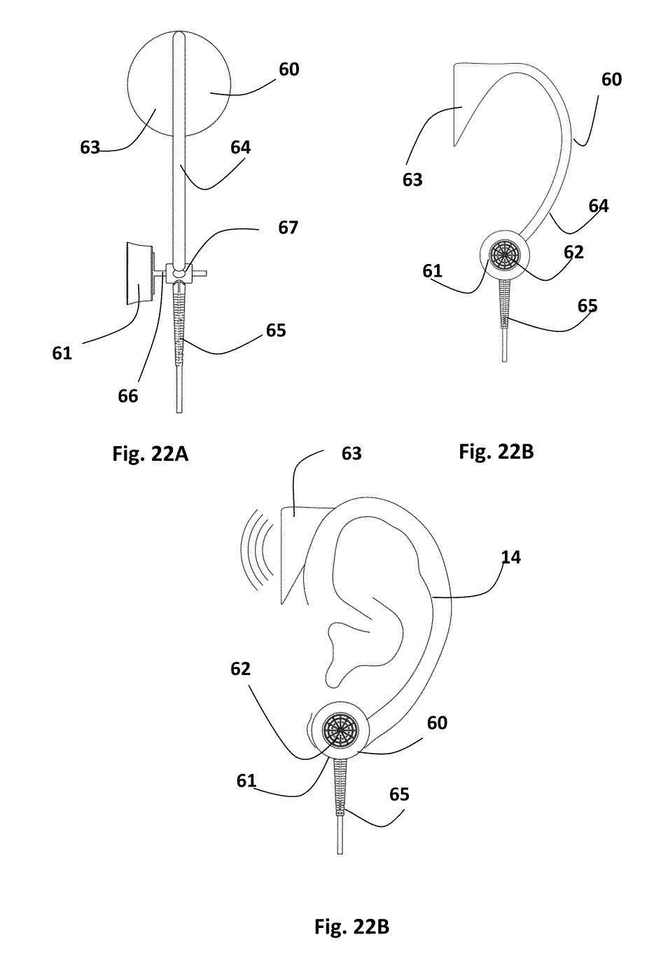

FIGS. 22A-22C show another embodiment of a set including an earring 60 having two audio speakers 62 and 63 integrated therein and an electric connector type signal unit 65 fastenable to the earring 60. The earring 60 includes a speaker unit 61 having two speakers 62 and 63 and a cover 64 that also connects the two speakers 62 and 63. The earring 60 is configured such that the first speaker 62 will be located externally to the lobules of the subject's ear 14 and the second speaker 63 will be located behind the upper portion of the ear 14, when the earring is fastened to the ear 14, as shown in FIG. 22C. The cover 64 has an elongated curved portion that is designed to fit behind an ear of a subject. The signal unit 65 also serving as an earring fastener, allows electrically connecting the speakers 62 and 63 to an audio device or to an amplifier communicable with an audio device by connecting to a positive and a negative connections in the speaker unit 61.

According to some embodiments, the earring 60 may be designed such that a common electric input connection embedded therein splits the signal arriving from the audio device or amplifier to the two speakers 62 and 63. The earring 60 includes a stud 66 that also serves as one or two of the electric connections inputs (positive and/or negative) and can also be inserted into the piercing hole of the subject to attach the earring 60 thereto.

The signal unit 65 includes a fastening mechanism 67 for both physically attaching and electrically connecting the speaker unit 61 therewith for fastening the earring 60 to the ear 14 as well as for electrically connecting the speakers 62 and 63 thereof to the audio device or amplifier.

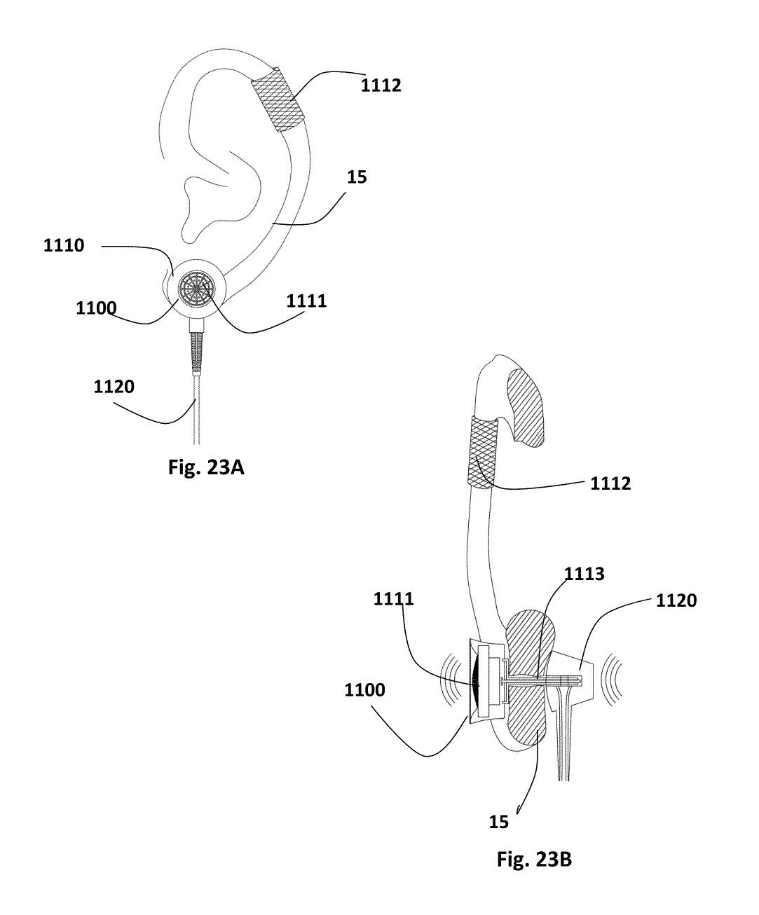

FIGS. 23A-23C show another embodiment of a set including an earring 1100 having a speaker unit 1110 with two audio speakers 1111 and 1112 integrated therein and an electric connector type signal unit 1120 fastenable to the speaker unit 1110. FIG. 23A shows how the earring 1100 is fastened to an ear 15. The second speaker 1112 is a chargeable Bluetooth speaker that can wirelessly communicate with the amplifier, audio player and/or the speaker unit 1110 for receiving data for playing audio signals corresponding to the received data/signals. The second speaker 1112 may also include a charging unit that includes a solar-plate having photovoltaic cells for solar charging or a charger configured for transforming movement into electric energy. FIG. 23B is a cross sectional view showing how a stud 1113 of the earring 1100 is inserted into a designated ear piercing, where the stud 1113 also includes electric connection nodes for electrically connecting to the signal unit 1120.

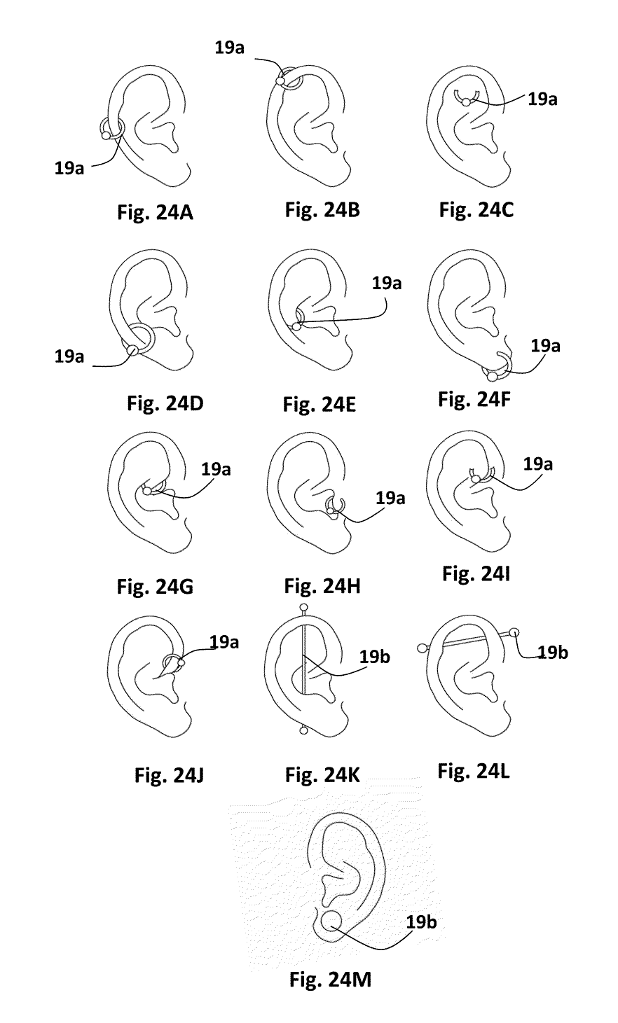

FIGS. 24A-24M show three types of earrings 19a-19c designs of the present invention, allowing various ways in which a person can wear each of them. FIGS. 24A-24J show a ring type earring 19a; FIGS. 24K-24L show an elongated rod type earring 19b; and FIG. 24M shows a button type earring 19c.

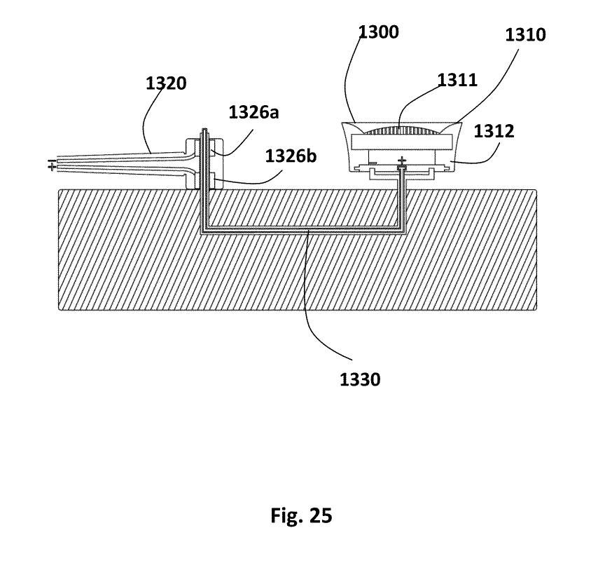

FIG. 25 shows an earring set 1300 with an earring with an audio speaker unit 1310 having one speaker 1311 integrated therein and a casing 1312, according to yet another embodiment of the invention, design for being fastened through a pair of pierced holes in the body of a person. The stud 1330 has a hook shape having rectangular angles where the signal unit 1320 includes electric connecting nodes 1326a and 1326b electrically connectable to electric nodes of the stud 1320 for electrically connecting the signal unit 1320 to the speaker 1311.

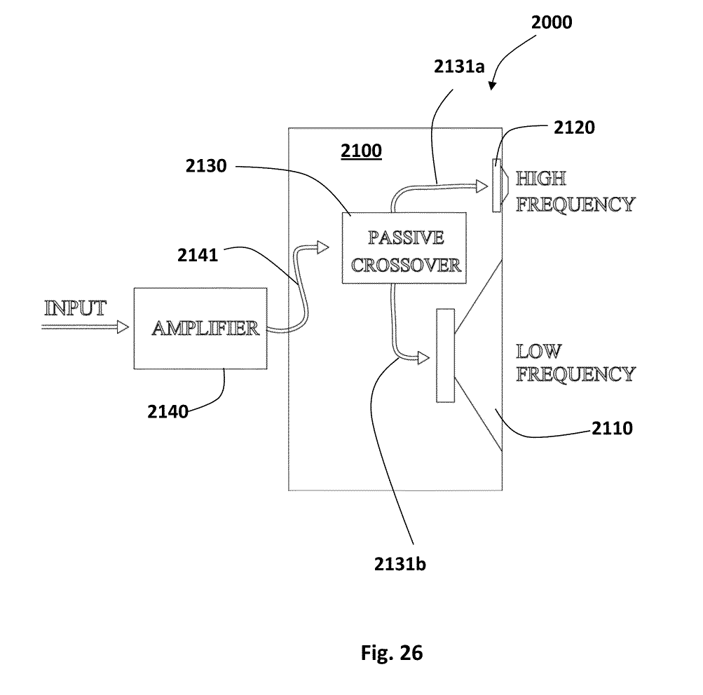

FIG. 26 shows an earring set 2000 including an earring 2100 and two different speakers: a first speaker 2110 configured for outputting different frequency bands of audio signals at a first output frequency range Δf₁ and a second speaker 2120 with a second output frequency Δf₂, where the first frequency range is higher than the second frequency range: Δf₁>Δf₂, according to another embodiment of the invention. This configuration may be used to allow creating a surround audio experience for the listener, where each of the speakers 2110 and 2120 has a different driver for outputting the higher and lower (bass) sounds, respectively therefrom. For example, the first speaker 2110 includes a tweeter drive and the second speaker 2120 includes a subwoofer drive.

As illustrated in FIG. 26, the system 2000 also includes a passive crossover unit 1230 (e.g. an electric or digital cable splitter) with split outputs 1231a and 1231b for splitting the inputted electric/digital signal to each speaker 2110/2120. In some cases, the signal is divided into data channels allowing easy division of the sound related signals according to the respective speaker 2110/2120 at each given moment. The system 2000 also includes an amplifier 2140 for amplifying signals received from an audio player where the output of the amplifier 2141 is configured for data transmission technology corresponding to that of the earring 2100.

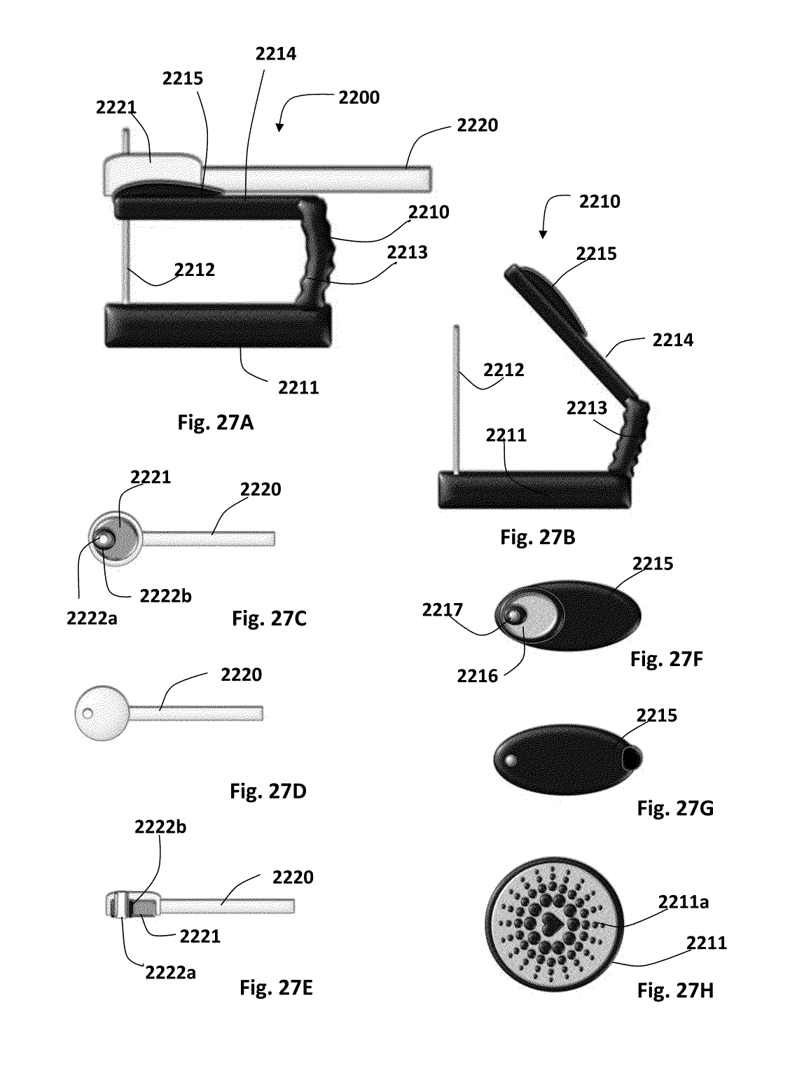

FIGS. 27A-27H show an earring set 2220, according to another embodiment of the invention, wherein the earring 2200 includes an earring 2210 and a signal unit 2220 also designed as a fastener configured to fasten the earring 2210 to a body part of a subject such an ear lobe. The earring 2210, as illustrated in FIGS. 27A-27B, includes: (i) a speaker unit 2211 including an audio speaker 2211a integrated therein; (ii) a connecting unit 2214 including a connector 2215 for connecting to output 2222 (see FIG. 27C) of the signal unit 2220 for receiving electric signal therefrom and directing them to the speaker 2211a; (iii|) an earring stud 2212 for inserting into a pierced hole of the body part also capable of directing electric signals therethrough; and (iv) a flexible connecting element 2213 that can include an electric wire threaded therethrough for electrically connecting the speaker unit 2211 and the receiving unit 2215.

According to some embodiments, the connecting unit allows physically attaching (e.g. fastening) to the signal unit 2220, where the signal unit 2220 includes electric output nodes 2222a and 2222b and the connecting unit 2214 includes an input node 2217 for electrically contacting output node 2222b, where the stud or a wire threaded therethrough is configured for contacting output node 2222a for closing an electric circuit for directing these electric signals originating from the amplifier and/or the audio player to the audio speaker 2211a.

FIGS. 27A-27B clearly show that the speaker unit 2210 is attachable to a first edge of the earring stud 2212 such that the audio speaker 2211a thereof will be located externally to the pierced hole of the body part (e.g. ear lobe) when the earring is worn.

FIGS. 27A and 27C-27G show how the signal unit 2220 includes a fastening inlet 2221 designed to fit into an input platform 2216 of the receiving unit 2214 for physically fastening the signal unit 2220 to the earring 2210. The fastening inlet 2221 and receiving unit 2214 can fasten to one another through magnetic means meaning that at least one of them includes a magnetic surface or element

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. An earring set comprising:
a) an earring for being fastened to at least one pierced hole of a body part of a subject, said earring comprising
an earring stud having a first and a second edge, said earring stud is configured for being inserted through said at least one pierced holes; and
a speaker unit that comprises at least one audio speaker said speaker unit is attachable to the first edge of said earring stud such that said speaker thereof is located externally to the at least one pierced hole when the earring is worn,
b) a signal unit communicable with said at least one speaker, said signal unit is configured for receiving electromagnetic signals and for directing said signals to each said speaker for outputting audio signals corresponding to said received electromagnetic signals,
wherein said stud comprises at least one electric connection for electrically connecting said at least one speaker to said signal unit.

2. The earring set according to claim 1 further comprising at least one connecting wire for electrically connecting said amplifier to said signal unit.

3. The earring set according to claim 1, wherein said signal unit comprises a Bluetooth receiver for wirelessly receiving electromagnetic signals from said amplifier, said amplifier comprising a wireless Bluetooth transceiver or transmitter.

4. The earring set according to claim 1, wherein said signal unit is connectable to the second edge of said earring stud thereby also serving as a fastener of the earring for fastening thereof to the body part.

5. The earring set according to claim 2, wherein said signal unit connects to said stud and comprises electric connecting outputs for transmitting electric signals from said amplifier to said at least one speaker, wherein said stud comprises electric output nodes for electrically connecting to said speaker.

6. The earring set according to claim 1, wherein said at least one audio speaker comprises two audio speakers each configured to be located at a different location over the body part of the subject.

7. The earring set according to claim 6, wherein said two audio speakers are configured for outputting audio signals at different frequency bands: a first audio speaker is configured to output at a first output frequency range Δf₁ and a second speaker at a second output frequency Δf₂, wherein the first frequency range is higher than the second frequency range: Δf₁>Δf₂.

8. The earring set according to claim 7 further comprising a passive crossover unit with split outputs for splitting inputted signals received from the amplifier to said two audio speaker, according to their respective frequency band.

9. The earring set according to claim 1 further comprising a flexible section for physically and electrically connecting said speaker unit and said signal unit.

10. The earring set according to claim 1 further comprising a microphone connected to the audio player via said amplifier.

11. The earring set according to claim 1 further comprising an amplifier for receiving signals from an audio player amplifying thereof, and outputting amplified corresponding signals to said signal unit via wireless or electric connection.

12. The earring set according to claim 1 further comprising a connecting element, wherein one electric wire is threaded through said earring stud and another electric wire is directed through said connecting element for electrically connecting said signal unit to said at least one speaker through said earring.

13. The earring set according to claim 12, wherein said connecting element comprises a flexible cover covering said electric wire.

14. An earring set comprising:
an earring stud having a first and a second edge, said earring stud is configured for being inserted through at least one pierced hole of a body part of a subject; and
a speaker unit that comprises at least one audio speaker said speaker unit is attachable to the first edge of said earring stud such that said speaker thereof is located externally to the at least one pierced hole when the earring is worn.
